(19) United States
(12) Patent Application Publication
(10) Pub. No.: US 2002/0032605 A1
(43) Pub. Date: Mar. 14, 2002

(54) System and method for providing a selectable gift certificate

(76) Inventor: Jonas Lee, New York, NY (US)

Correspondence Address: SOFER & HAROUN, L.L.P., 342 Madison Avenue, Suite 1921, New York, NY, 10173, US

(21) Appl. No.: 09/875,808

(22) Filed: Jun. 6, 2001

Related U.S. Application Data
(60) Provisional application No. 60/209,647, filed on Jun. 5, 2000.
(60) Provisional application No. 60/235,856, filed on Sep. 27, 2000.

(51) Int. Cl. G06F 17/60

(52) U.S. Cl. 705/14; 705/26; 705/39

(57) ABSTRACT

A system for providing gift certificates which comprises a user terminal and a server coupled to the user terminal via the Internet. The server is configured to provide to the user terminal an interface for enabling a user of the user terminal to purchase a first gift certificate, also referred to as a Supercertificate™. The server comprises a transmission means for transmitting the first gift certificate to a recipient, such as by e-mail message when the first gift certificate is digital or by mail when the first gift certificate is physical. The first gift certificate is redeemable by the recipient for a second gift certificate, such as a merchant gift certificate, selected by said recipient. In one embodiment, the user selects a category to be associated with the first gift certificate, and the recipient redeems the first gift certificate for a second gift certificate that corresponds to the selected category.

### CROSS-REFERENCE TO RELATED APPLICATIONS

This application is related to Applicant's co-pending U.S. Provisional Patent Applications having Ser. Nos. 60/209,647 (filed Jun. 5, 2000) and 60/235,856 (filed Sep. 27, 2000), the disclosure of which are both incorporated by reference herein as fully as if set forth in their entirety.

### FIELD OF THE INVENTION

This invention relates to a system and method for providing a gift certificate to a recipient, and more particularly, to a system and method that enables a user of an addressable website to purchase a first gift certificate which is redeemable by a recipient for a second, recipient-selectable gift certificate.

### BACKGROUND

Gift certificates have long been used to enable a recipient to select his or her own gift from a particular merchant. Typically, a purchaser physically goes to the location of a merchant's store, purchases the gift certificate over the counter from one of the merchant's employees, and then delivers the gift certificate to the intended recipient.

In order to eliminate the requirement that the purchaser physically go to the merchant's store, there have been developed systems wherein gift certificates are purchased at a kiosk specifically adapted for the purpose. Other systems enable on-line purchases of gift certificates from the purchaser's computer terminal, for improved convenience. However, the purchaser may not be familiar with the personal taste, or needs, of the recipient. Thus, despite the additional convenience that the previous systems provide to the purchaser of a gift certificate, the systems do not enable the purchaser to provide a gift certificate which is particularly suited to the recipient.

Thus, there exists a need for a system and method that enables a purchaser to provide to a recipient the most suitable gift certificate.

### SUMMARY OF THE INVENTION

The present invention, in accordance with one embodiment, provides a system and method that enables a user of an addressable website to purchase a first gift certificate, wherein the first gift certificate is redeemable by a recipient for a second, or merchant, gift certificate. Specifically, the system and method enables a user to purchase a SuperCertificate™, which comprises a gift certificate redeemable for a gift certificate from a merchant. According to a preferred embodiment, in order to redeem the SuperCertificate for a merchant gift certificate, a recipient accesses the addressable website at which the SuperCertificate was purchased. Thus, the SuperCertificate enables a recipient to obtain via the system of the present invention one or more gift certificates redeemable at a merchant of their own choosing.

When a customer places an order for a SuperCertificate, the system's interface also prompts the customer to enter a recipient's name to whom the SuperCertificate is desired to be sent, the recipient's address, a desired value of the SuperCertificate, and a credit card number for payment purposes. In this case, the address provided by the customer may be either the physical residence of the recipient or an e-mail address of the recipient.

If the address provided by the customer is the physical residence of the recipient, the system then sends by mail the SuperCertificate having the designated value. In addition, the SuperCertificate includes data corresponding to an Internet website (i.e.—the system website) or a telephone number. The recipient either accesses the website or else calls the telephone number in order to order from the system the merchant gift certificate of their choosing. The SuperCertificate also includes an identification number, insuring that the person who is redeeming the SuperCertificate is the recipient who was intended to receive it. The merchant gift certificate which the recipient selects is then mailed to the recipient. The recipient redeems the merchant gift certificate in a manner acceptable to the merchant, such as by visiting the merchant's store, or by ordering an item from the merchant's catalog on the telephone or on-line.

If, on the other hand, the address provided by the customer is the e-mail address of the recipient, the system then sends via Internet a digital copy of the SuperCertificate having the designated value. Again, the SuperCertificate includes data corresponding to an Internet website (i.e.—the system website) or a telephone number. The recipient either accesses the website or else calls the telephone number to order from the system the merchant gift certificate of their choosing. The digital SuperCertificate also includes an identification number, insuring that the person who is redeeming the SuperCertificate is the recipient who was intended to receive it. The merchant gift certificate which the recipient selects is then mailed to the recipient. The recipient redeems the merchant gift certificate in a manner acceptable to the merchant, such as by visiting the merchant's store, or by ordering an item from the merchant's catalog on the telephone or on-line.

In another embodiment, the system and method enables the user of the website to purchase a first gift certificate corresponding to a user-defined category. A “category” may correspond to a type of gift (such as clothing, jewelry, etc.), a particular demographic (such as a male over 50 years of age, a woman between the ages of 20 and 30, etc.) or the like. Once received by a recipient, the first gift certificate is redeemable by the recipient for a second, recipient-selectable gift certificate within the user-defined category. In this manner, a purchaser of a gift certificate may convey to the recipient that an effort was made to select the most suitable gift certificate for the recipient.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a diagram that illustrates the salient features of an on-line gift certificate system, in accordance with one embodiment of the present invention;

FIG. 2 is a flow chart that illustrates the steps performed during the operation of the system, in accordance with one embodiment of the invention;

FIG. 3 is an illustration of an interface that may be employed to purchase a SuperCertificate, in accordance with one embodiment of the invention;

FIG. 4 is an illustration of an interface that may be employed to redeem a SuperCertificate, in accordance with one embodiment of the invention;

FIG. 5 is a flow chart that illustrates the steps performed in order to provide gift certificates in user-defined categories, in accordance with one embodiment of the invention; and

FIG. 6 is a flow chart that illustrates the steps performed in order to provide gift certificates in user-defined categories, in accordance with another embodiment of the invention.

### DETAILED DESCRIPTION OF THE DRAWINGS

The present invention is directed to a system and method that enables a user of an addressable website to purchase a gift certificate selectable by a recipient. Specifically, the system and method enables a user to purchase a SuperCertificate™, which comprises a gift certificate redeemable for a gift certificate from a merchant. Thus, the SuperCertificate enables a recipient to obtain via the system of the present invention one or more gift certificates redeemable at a merchant of their own choosing.

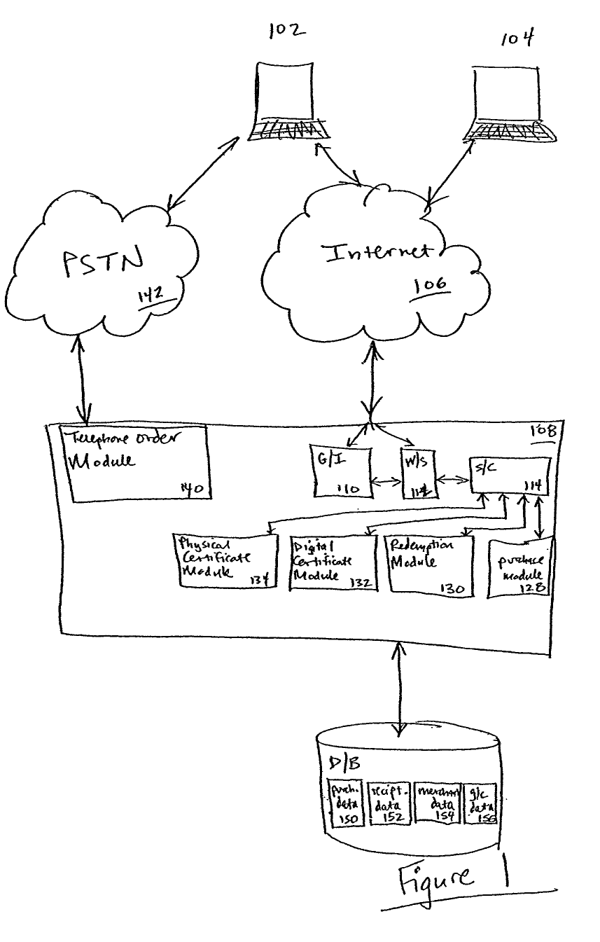

FIG. 1 illustrates a communications system 100, in accordance with one embodiment of the present invention. In the embodiment shown, purchaser terminal 102 and recipient terminal 104, such as personal computers, hand-held devices or the like, are coupled to Internet 106. Also coupled to Internet 106 is processor 108.

Processor 108 comprises web server 112 which is configured to maintain an addressable web site. Processor 108 also comprises viewer display interface 110 that provides an interface for users of the computer terminals to communicate with processor 108, as will be described further below. System controller 114 is coupled to web server 112, and controls the operation of processor 108. Processor 108 also comprises modules which perform various operations (although it is noted that these modules need not be discrete components but may instead be any combination of components, or software, which provide the desired functionality described below).

For instance, in the embodiment shown, processor 108 comprises purchase module 128, which is configured to query a purchaser for, and to receive and process in response, data corresponding to the purchase of a SuperCertificate. Purchase module 128 provides system controller 114 with a workflow such that, according to one embodiment of the invention, purchasers enter various data about the desired SuperCertificate, such as the intended recipient's name and address, the amount of the gift certificate, and the type of gift certificate desired.

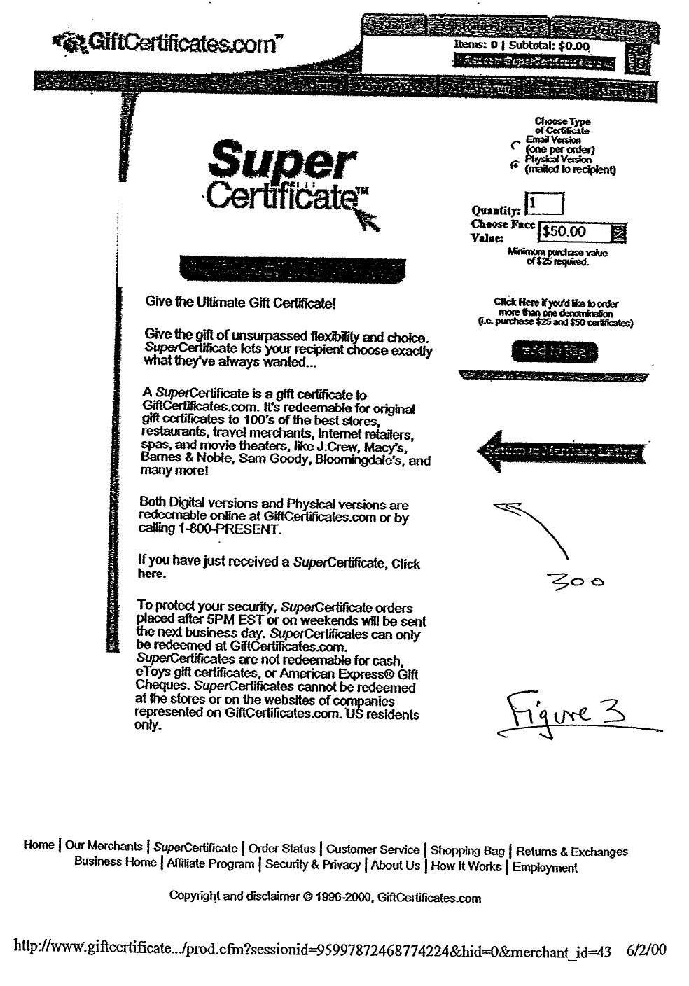

FIG. 3 is a sample purchasing interface 300 that illustrates various fields that may be employed to enter purchase data, according to one embodiment of the invention. Interface 300 shows data entry fields for the quantity, face value, and has links to additional interfaces that list the participating merchants along with credit card data entry fields.

Processor 108 also comprises redemption module 130, which is configured to query a recipient for, and to receive and process in response, data corresponding to the redemption of a SuperCertificate. Redemption module 130 provides system controller 114 with a workflow such that, according to one embodiment of the invention, recipients enter authorization data corresponding to the desired SuperCertificate.

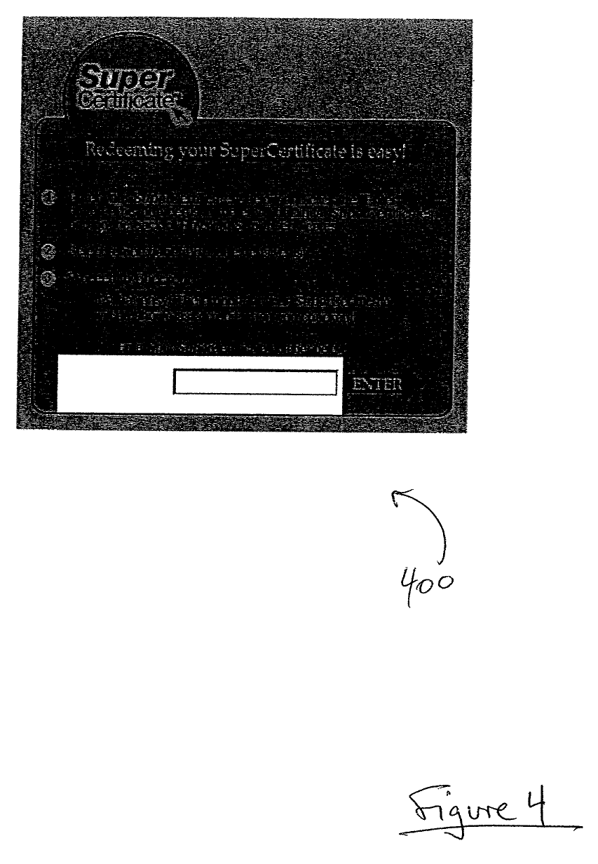

FIG. 4 is a sample redemption interface 400 that illustrates various instructions to the person redeeming the SuperCertificate. Interface 400 also shows an authorization data entry field that is employed by the recipient to enter the SuperCertificate authorization code (as will be explained in greater detail below), according to one embodiment of the invention. Interface 400 also has links to additional interfaces that list the participating merchants and provide checkout, or transaction completion, data.

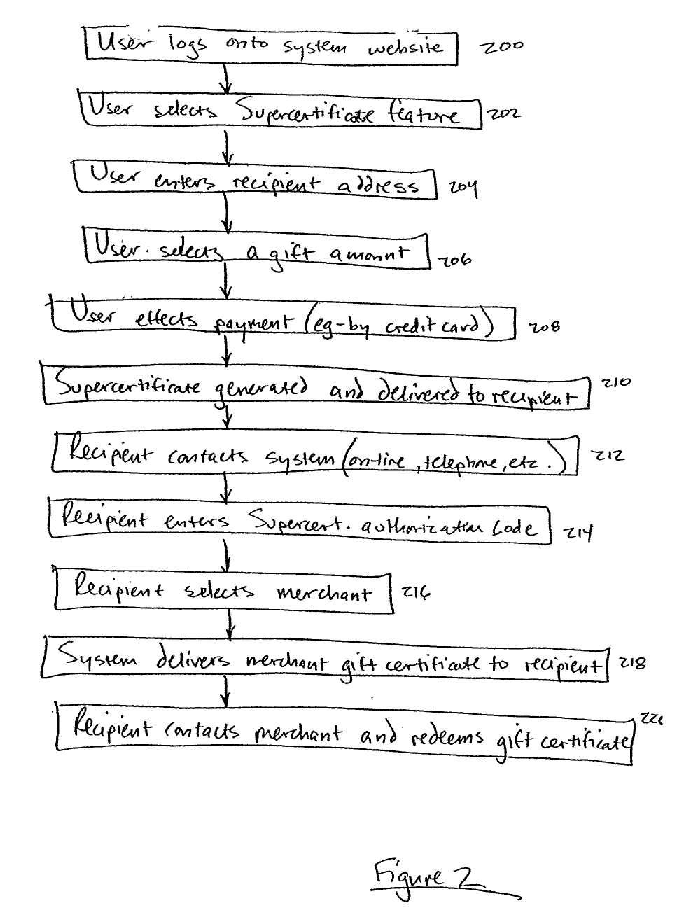

Processor 108 also comprises digital certificate module 132, which is configured to generate and transmit digital gift certificates when the purchaser of the SuperCertificate specifies that a digital gift certificate is to be sent to the recipient. For instance, as will be described in greater detail below in connection with the flowchart of FIG. 2, the system of the present invention may be employed to generate and transmit a digital gift certificate having an authorization code. According to one embodiment of the invention, digital certificate module 132 is configured to receive from the purchaser a recipient's e-mail address, and upon payment by the purchaser, to generate and transmit the gift certificate to the appropriate recipient.

Processor 108 also comprises physical certificate module 134, which is configured to process orders for physical gift certificates when the purchaser of the SuperCertificate specifies that a physical gift certificate is to be sent to the recipient. For instance, as will be described in greater detail below in connection with the flowchart of FIG. 2, the system of the present invention may be employed to facilitate the delivery of a physical gift certificate having an authorization code. According to one embodiment of the invention, physical certificate module 134 is configured to receive from the purchaser a recipient's residence or mailing address, and upon payment by the purchaser, to process and deliver a physical gift certificate to the appropriate recipient.

Processor 108 also comprises telephone order module 140, which is configured to process orders which are received by the system via public switched telephone network (“PSTN”) 142. Telephone order module 140 is employed when the recipient of the SuperCertificate elects to redeem the gift certificate (either physical or digital) by telephone. For instance, as will be described in greater detail below in connection with the flowchart of FIG. 2, the system of the present invention may employ a telephone number which a recipient calls to redeem the certificate instead of doing so on-line. As discussed above, the system may be configured such that the recipient provides the authorization code that corresponds to the gift certificate, either by telling an operator or by entering the code on a touch tone keypad. Once received, the gift certificate of the desired merchant is then selected by the recipient and is delivered to the recipient.

Processor 108 is also coupled to database 120 which, according to one embodiment, is configured to store data corresponding to purchasers, recipients, merchants and the various gift certificates that have been purchased. Specifically, database 120 comprises purchaser data module 150 having data corresponding to and entered by purchasers, recipient data module 152 having data corresponding to and entered by recipients, merchant data module 154 having data corresponding to and entered by merchants, and gift certificate data module 156 having data corresponding to specific gift certificate offers and gift certificates that have been purchased (e.g.—authorization codes, amounts, etc.).

FIG. 2 is a flow chart that illustrates the steps that are performed by purchasers and recipients when operating system 100, in accordance with one embodiment of the invention. At step 200, a purchaser logs on to the addressable web site corresponding to processor 108 via computer terminal 102 and Internet 106. At step 202, the purchaser selects the SuperCertificate feature of the present invention, such as by clicking on a SuperCertificate link.

At step 204, processor 108 queries for, and the purchaser enters, the intended recipient's address. In a preferred embodiment, the recipient's address that the purchaser enters is the recipient's physical or mailing address at which the recipient receives mail delivered by a postal carrier. In another embodiment, and as will be discussed further below, the recipient's address that the purchaser enters is the recipient's on-line or e-mail address at which the recipient receives e-mail messages. At step 206, processor 108 queries for, and the purchaser enters, a gift certificate amount.

At step 208, the purchaser effects payment for the gift certificate, such as by providing the system with credit card information. The system is preferably configured to verify the purchaser's credit card information, such as by contacting the credit card issuer to confirm availability of credit, and to perform the transaction. At step 210, the SuperCertificate is delivered to the recipient. The manner of delivery of the SuperCertificate is dependent upon whether the purchaser entered the recipient's physical address or e-mail address at step 204. If the purchaser entered the recipient's physical address at step 204, then a physical version of the SuperCertificate will be delivered to the recipient's physical address. If the purchaser entered the recipient's e-mail address at step 204, then an electronic or digital version of the SuperCertificate will be delivered to the recipient's e-mail address.

At step 212, the recipient contacts the issuer of the SuperCertificate. According to one embodiment, the recipient contacts the issuer of the SuperCertificate by logging on to the same addressable website onto which the purchaser logs on at step 200. If the recipient receives a physical version of the SuperCertificate, the website address may be printed on the SuperCertificate, and the recipient enters the website address in a typical on-line web browser to gain access to the website. Alternatively, if the recipient receives a digital version of the SuperCertificate, the recipient accesses the website by clicking on a link which is provided in the digital message.

According to another embodiment, the recipient contacts the issuer of the SuperCertificate by calling a predetermined telephone number that is configured to communicate with the recipient, such as by a human operator or by touch tone features. If the recipient receives a physical version of the SuperCertificate, the predetermined telephone number may be printed on the SuperCertificate, while if the recipient receives a digital version of the SuperCertificate, the predetermined telephone number is provided in the digital message.

At step 214, the recipient enters the SuperCertificate authorization code that corresponds to the SuperCertificate that was sent. The authorization code enables the system to confirm that the person who is redeeming the SuperCertificate is in fact the person who was intended to receive it.

At step 216, the recipient redeems the SuperCertificate by selecting the merchant from which the recipient would like to receive the value of the gift certificate. According to the embodiment in which the recipient contacts the issuer of the SuperCertificate at step 212 by logging on to the addressable website, the recipient may select from a list of merchants displayed on the website. Alternatively, according to the embodiment in which the recipient contacts the issuer of the SuperCertificate by calling a predetermined telephone number, a human operator or a voice message may provide the recipient with the various merchants to select from.

At step 218, the system delivers to the recipient the merchant gift certificate that was selected at step 216. As previously discussed, the manner of delivery of the merchant gift certificate, like the manner of delivery of the SuperCertificate, may be to the recipient's physical address or e-mail address. In a preferred embodiment, a physical version of the merchant gift certificate will be delivered to the recipient's physical address, although the present invention also contemplates that an electronic or digital version of a merchant gift certificate will be delivered to the recipient's e-mail address.

At step 220, the recipient then redeems the merchant gift certificate by visiting the merchant's store and exchanging the merchant gift certificate for goods or services. Alternatively, the recipient can redeem the merchant gift certificate by contacting the merchant via telephone or on-line and ordering goods and services from the merchant's catalog.

There may be instances, however, when the purchaser desires to give to a recipient a SuperCertificate but feels that the SuperCertificate is too impersonal. For instance, there are some people who feel that a gift is inadequate unless the purchaser of the gift considers the wants, needs or taste of the recipient. For these people, it is important for them to convey to the recipient that they thought seriously about what type of gift the recipient would like to receive. According to one embodiment, the system and method of the present invention is configured such that a purchaser is able to convey to the recipient that he or she considered the tastes of the recipient when purchasing a SuperCertificate.

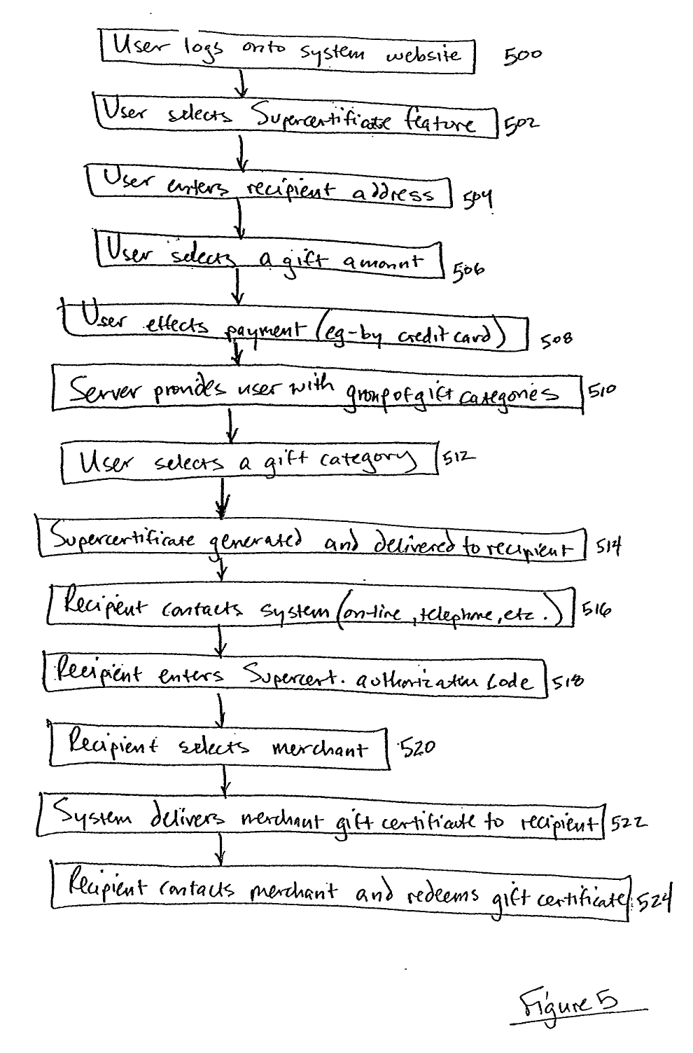

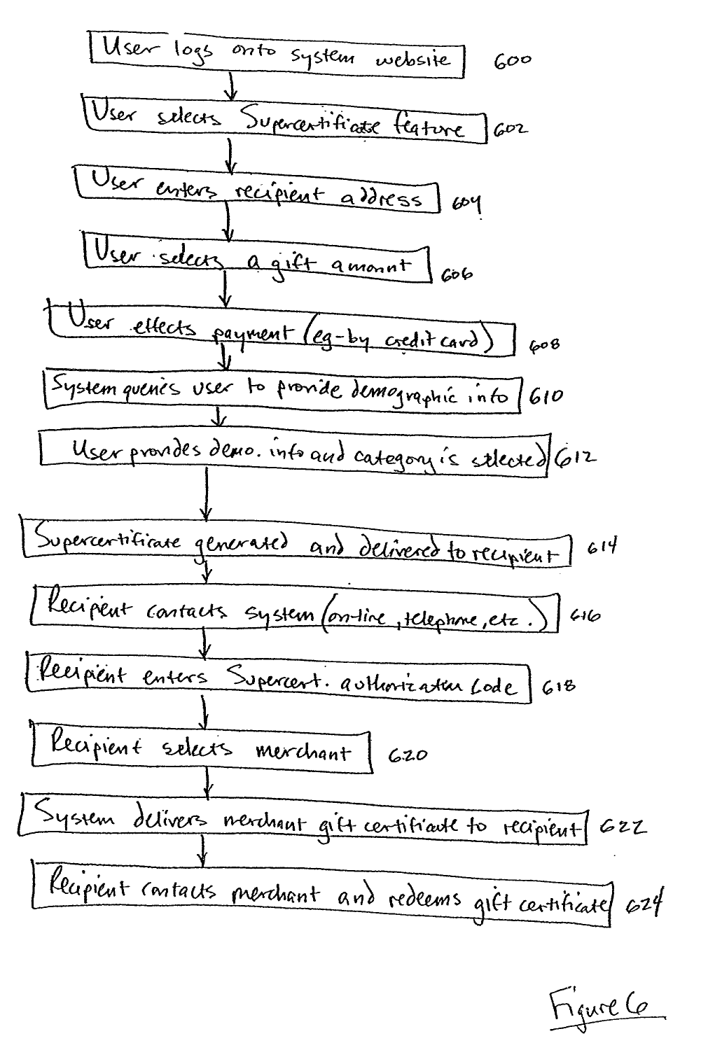

Thus, in accordance with one embodiment of the invention, a user of the website may purchase a first gift certificate corresponding to a user-defined category, wherein the first gift certificate is redeemable by a recipient for a second, recipient-selectable gift certificate within the user-defined category. FIG. 5 is a flow chart that illustrates the steps that are performed, in accordance with one embodiment, to provide and redeem a first gift certificate wherein the user-defined categories are types of merchants that offer a specific product or service. FIG. 6, on the other hand, is a flow chart that illustrates the steps that are performed, in accordance with one embodiment, to provide and redeem a first gift certificate wherein the user-defined category corresponds to demographic information relating to the recipient. FIG. 6 is discussed in detail below.

Referring to FIG. 5, at step 500, a purchaser logs on to the addressable web site corresponding to processor 108 via computer terminal 102 and Internet 106. At step 502, the purchaser selects the SuperCertificate feature of the present invention, such as by clicking on a SuperCertificate link. At step 504, processor 108 queries for, and the purchaser enters, the intended recipient's address. As previously discussed, the recipient's address may be either the recipient's residence or an e-mail address. At step 506, processor 108 queries for, and the purchaser enters, a gift certificate amount. At step 508, the purchaser pays for the gift certificate, such as by providing the system with credit card information.

At step 510, the system provides the user with a group of gift categories. In this case, each of the gift categories comprise a type of merchant that offers specific goods or services. For instance, a first gift category may comprise “clothing” which includes various merchants that sell clothing, while a second gift category may comprise “jewelry” which includes various merchants that sell jewelry, etc. Of course, any categories may be employed by the system, and the present invention is not intended to be limited to those discussed herein.

At step 512, the user selects one of the gift categories provided in step 510. Advantageously, the user considers the wants, needs or tastes of the recipient and selects the gift category which is most appropriate for the recipient. Thus, for instance, if the purchaser knows that the recipient is in need of new clothing, the user will select a gift category referred to as “clothing.”

At step 514, the SuperCertificate is generated and delivered to the recipient. As previously discussed, the manner in which the SuperCertificate is generated and delivered is dependent upon whether the purchaser entered the recipient's physical address or e-mail address at step 504. If the purchaser entered the recipient's physical address at step 504, then a physical version of the SuperCertificate will be delivered to the recipient's physical address. If the purchaser entered the recipient's e-mail address at step 504, then an electronic or digital version of the SuperCertificate will be delivered to the recipient's e-mail address.

At step 516, the recipient contacts the issuer of the SuperCertificate. According to one embodiment, the recipient contacts the issuer of the SuperCertificate by logging on to the website, while in another embodiment, the recipient contacts the issuer of the SuperCertificate by calling a predetermined telephone number. Both of these methods were previously discussed above.

At step 518, the recipient enters the SuperCertificate authorization code that corresponds to the SuperCertificate that was sent to confirm the recipient's identity. At step 520, the recipient redeems the SuperCertificate by selecting the merchant from which the recipient would like to receive a gift certificate. Advantageously, the recipient may only redeem the SuperCertificate for the gift certificate of a merchant that is included in the gift category selected by the user at step 512. According to the embodiment in which the recipient contacts the issuer of the SuperCertificate at step 212 by logging on to the addressable website, the recipient may select from a list of merchants displayed on the website. Alternatively, according to the embodiment in which the recipient contacts the issuer of the SuperCertificate by calling a predetermined telephone number, a human operator or a voice message may provide the recipient with the various merchants to select from.

At step 522, the system delivers to the recipient the merchant gift certificate that was selected at step 520. At step 524, the recipient then redeems the merchant gift certificate by visiting the merchant's store at exchanging the merchant gift certificate for goods or services. Alternatively, the recipient can redeem the merchant gift certificate by contacting the merchant via telephone or on-line and ordering goods and services from the merchant's catalog.

As previously mentioned, FIG. 6 is a flow chart that illustrates the steps that are performed, in accordance with one embodiment, to provide and redeem a first gift certificate wherein the user-defined category corresponds to demographic information relating to the recipient. At step 600, a purchaser logs on to the addressable website. At step 602, the purchaser selects the SuperCertificate feature. At step 604, processor 108 queries for, and the purchaser enters, the intended recipient's address. At step 606, processor 108 queries for, and the purchaser enters, a gift certificate amount. At step 608, the purchaser pays for the gift certificate, such as by providing the system with credit card information.

At step 610, the system queries the user to provide demographic information corresponding to the recipient. For instance, the system may query the user to enter demographic information such the recipient's age, sex, geographical location, interests, etc. Of course, any such information may be queried for by the system, and the present invention is not intended to be limited to those discussed herein.

At step 612, the user enters the demographic information. In addition, based upon the demographic information entered, the system determines a category into which the recipient belongs. For instance, according to one embodiment, processor 108 comprises predetermined demographic categories. If a user enters that a recipient is male, age 26 and lives in New York City, processor 108 may select a demographic category such as “Urban Male, age 20-30.” Similarly, if a user enters that a recipient is female, age 39 and lives in Nebraska, processor 108 may select a demographic category such as “Rural Female, age 30-40.” Each demographic category has various merchants associated therewith which have been predetermined to be likely to appeal to the members of a demographic category. Thus, the system is configured to approximate the wants, needs or tastes of a recipient.

According to another embodiment of the invention, the system may also be configured such that the user is queried to select a demographic category him or herself. For instance, the user is provided with an interface which lists the available demographic categories, such as “Urban Male, Age 20-30” or “Rural Female, Age 30-40”, etc. The user then selects from the list of demographic categories which category should apply to the recipient of the SuperCertificate. In this way, the user may better approximate the recipient's tastes (e.g.—a recipient that dresses in clothing which is typically worn by younger persons).

At step 614, the SuperCertificate is generated and delivered to the recipient, either physically to the recipient's residence or digitally to the recipient's e-mail address. At step 616, the recipient contacts the issuer of the SuperCertificate by logging on to the website or by calling a predetermined telephone number. At step 618, the recipient enters the SuperCertificate authorization code that corresponds to the SuperCertificate that was sent to confirm the recipient's identity.

At step 620, the recipient redeems the SuperCertificate by selecting the merchant from which the recipient would like to receive a gift certificate. Advantageously, the recipient may only redeem the SuperCertificate for the gift certificate of a merchant that is included in the demographic category selected at step 612.

At step 622, the system delivers to the recipient the merchant gift certificate that was selected at step 620. At step 624, the recipient then redeems the merchant gift certificate by visiting the merchant's store or by contacting the merchant via telephone, and by obtaining goods or services having a value equal to the gift certificate.

Of course, the present invention also contemplates that still other methods of categorization may be employed in order to convey to a recipient that the purchaser took the time to select the most suitable gift certificate for that recipient. For instance, in one embodiment, a user selects several merchants from which a recipient can redeem a SuperCertificate. Thus, if a user knows that a recipient likes to shop at several particular stores, then the user may select those stores as a “category”, and the recipient may select to receive a gift certificate from one of those stores only. Thus, a user can demonstrate to the recipient that it made an effort to provide a gift certificate tailored to the recipient's taste, without limiting the recipient's choice of redemption to only a single merchant.

While only certain features of the invention have been illustrated and described herein, many modifications, substitutions, changes or equivalents will now occur to those skilled in the art. It is therefore, to be understood that the appended claims are intended to cover all such modifications and changes that fall within the true spirit of the invention.

I claim:

1. A system for providing gift certificates, said system comprising:
a user terminal;
a server coupled to said user terminal via Internet and configured to provide to said user terminal an interface for enabling a user of said user terminal to purchase a first gift certificate, wherein said server comprises transmission means for transmitting said first gift certificate to a recipient, wherein said first gift certificate is redeemable by said recipient for a second gift certificate selected by said recipient.

2. The system in accordance with claim 1, wherein said interface enables said user to enter an address corresponding to said recipient.

3. The system in accordance with claim 2, wherein said address corresponding to said recipient is an e-mail address.

4. The system in accordance with claim 3, wherein said first gift certificate is digital.

5. The system in accordance with claim 4, wherein said transmission means is configured to transmit to said recipient's e-mail address an e-mail message comprising said first gift certificate.

6. The system in accordance with claim 5, wherein said system further comprises a telephone order module for redeeming said first gift certificate for said second gift certificate via telephone.

7. The system in accordance with claim 6, wherein said e-mail message further comprises a telephone number associated with said telephone order module.

8. The system in accordance with claim 5, wherein said server is configured to provide a redemption interface to said recipient for redeeming said first gift certificate for said second gift certificate.

9. The system in accordance with claim 8, wherein said e-mail message further comprises a web address of said server so as to enable said recipient to log on to said web site maintained by said server, and wherein upon said recipient logging on, said server is configured to provide said redemption interface to said recipient.

10. The system in accordance with claim 8, wherein said e-mail message further comprises a hypertext link to said addressable website of said server, wherein upon said recipient clicking on said hypertext link, said server is configured to provide said redemption interface to said recipient.

11. The system in accordance with claim 1, wherein said first gift certificate has a identification means, and said transmission means is further configured to transmit to said recipient said identification means.

12. The system in accordance with claim 11, wherein, in order for said recipient to redeem said first gift certificate for said second gift certificate, said recipient is required to provide said identification means.

13. The system in accordance with claim 2, wherein said address corresponding to said recipient is a mailing address.

14. The system in accordance with claim 13, wherein said first gift certificate is physical.

15. The system in accordance with claim 14, wherein said transmission means is configured to mail to said recipient's mailing address said first gift certificate.

16. The system in accordance with claim 15, wherein said system further comprises a telephone order module for enabling said recipient to redeem said first gift certificate for said second gift certificate via telephone.

17. The system in accordance with claim 16, wherein said first gift certificate comprises a telephone number associated with said telephone order module.

18. The system in accordance with claim 15, wherein said server is configured to provide a redemption interface to said recipient for redeeming said first gift certificate for said second gift certificate.

19. The system in accordance with claim 18, wherein said first gift certificate further comprises a web address of said server so as to enable said recipient to log on to said web site maintained by said server, and wherein upon said recipient logging on, said server is configured to provide said redemption interface to said recipient.

20. The system in accordance with claim 1, wherein said user selects a category to be associated with said first gift certificate, such that said first gift certificate may be redeemed by said recipient for a second gift certificate that corresponds to said selected category.

21. The system in accordance with claim 1, wherein said second gift certificate is a merchant gift certificate.

22. A method for providing gift certificates, said method comprising the steps of:
a user logging on via a user terminal to an addressable web site maintained by a server;
said user selecting from an interface provided to said user terminal by said server a first gift certificate;
transmitting, via a transmission means of said server, said first gift certificate to a recipient;
said recipient redeeming said first gift certificate for a second gift certificate selected by said recipient.

23. The method in accordance with claim 22, further comprising the step of said user entering via said interface an address corresponding to said recipient.

24. The method in accordance with claim 23, wherein said address corresponding to said recipient is an e-mail address.

25. The method in accordance with claim 24, wherein said first gift certificate is digital.

26. The method in accordance with claim 25, further comprising the step of said transmission means transmitting to said recipient's e-mail address an e-mail message comprising said first gift certificate.

27. The method in accordance with claim 26, wherein said step of redeeming said first gift certificate for said second gift certificate is initiated by said recipient by calling a telephone order module coupled to said server.

28. The method in accordance with claim 27, wherein said e-mail message further comprises a telephone number associated with said telephone order module.

29. The method in accordance with claim 26, further comprising the step of said server providing a redemption interface to said recipient for redeeming said first gift certificate for said second gift certificate.

30. The method in accordance with claim 29, wherein said e-mail message further comprises a web address of said server, and wherein said method further comprises the steps of:
said recipient logging on to said website maintained by said server; and
said server providing said redemption interface to said recipient.

31. The method in accordance with claim 29, wherein said e-mail message further comprises a hypertext link to said addressable website of said server, and wherein said method further comprises the steps of:
said recipient clicking on said hypertext link; and
said server providing said redemption interface to said recipient.

32. The method in accordance with claim 22, wherein said method further comprises the steps of:
providing said first gift certificate with an identification means; and
said transmission means transmitting said identification means to said recipient.

33. The method in accordance with claim 32, said method further comprising the step of said recipient providing said identification means in order for said recipient to redeem said first gift certificate for said second gift certificate.

34. The method in accordance with claim 23, wherein said address corresponding to said recipient is a mailing address.

35. The method in accordance with claim 34, wherein said first gift certificate is physical.

36. The method in accordance with claim 35, further comprising the step of said transmission means transmitting to said recipient's mailing address said said first gift certificate.

37. The method in accordance with claim 36, wherein said step of redeeming said first gift certificate for said second gift certificate is initiated by said recipient by calling a telephone order module coupled to said server.

38. The method in accordance with claim 37, wherein said first gift certificate comprises a telephone number associated with said telephone order module.

39. The method in accordance with claim 36, further comprising the step of said server providing a redemption interface to said recipient for redeeming said first gift certificate for said second gift certificate.

40. The method in accordance with claim 39, wherein said first gift certificate further comprises a web address of said server, and wherein said method further comprises the steps of:
said recipient logging on to said website maintained by said server; and
said server providing said redemption interface to said recipient.

41. The method in accordance with claim 22, further comprising the steps of:
said user selecting a category to be associated with said first gift certificate;
said recipient redeeming said first gift certificate for a second gift certificate that corresponds to said selected category.

42. The method in accordance with claim 22, wherein said second gift certificate is a merchant gift certificate.
